(19) United States
(12) Patent Application Publication
(10) Pub. No.: US 2005/0040017 A1
(43) Pub. Date: Feb. 24, 2005

(54) Belt conveyor frame and method for manufacturing the same

(75) Inventors: Otto O. Kinnunen, Parkano (FI); Tero J.J. Majuri, Tampere (FI); Markku A. Vitasalo, Tampere (FI)

Correspondence Address: OLIFF & BERRIDGE, PLC, P.O. BOX 19928, ALEXANDRIA, VA, 22320, US

(73) Assignee: Metso Minerals (Tampere) OY, Tampere (FI)

(21) Appl. No.: 10/504,062

(22) PCT Filed: Dec. 1, 2003
(86) PCT No.: PCT/FI03/00912

(30) Foreign Application Priority Data
Dec. 4, 2002 (FI) 20022141

(51) Int. Cl. B65G 15/08

(52) U.S. Cl. 198/825

(57) ABSTRACT

A belt conveyor frame and methods for manufacturing the same are disclosed, the cross section of the sidewall of the belt conveyor frame having at least two bends made thereto in two successive angles of opposite direction, whereby the sidewall cross section has essentially the shape of letter S or Z.

The invention relates to belt conveyors intended for transport of bulk materials.

In the prior art it has been conventional to construct a belt conveyor by welding or bolting the conveyor frame into an assembly comprising two sidewall elements that are fabricated by welding or bending and are connected to each other by transverse members joining the sidewall elements. Conventionally, the sidewall element is fabricated by forming a trimmed length of sheet steel by shearing and bending into a sidewall continuous section whereto are attached, most usually by welding, stiffener plates compliant with the shape of the sidewall continuous section in order to improve the stiffness of the sidewall element.

Conventionally, a continuous section used as the conveyor longitudinal sidewall is shaped so that each one of the successive bends are made into desired angles of the same direction so that the continuous section finally assumes the shape of, e.g., letter C or G. In this context, the term “same direction” must be understood to indicate that the successive bending angles in regard to the vertical plane of the continuous section are consistently either positive or respectively negative.

However, the bending shapes of conventional continuous sections are complicated by the problem that the installation of conveyor accessories such as sidewall deckle, dust cover and hoses/piping therein is cumbersome, costly and time-consuming.

In prior-art conveyor constructions, the conveyor accessories mounted on the conveyor frame are generally fastened with screws. However, conventional conveyor constructions conceal simultaneous access to both sides of the screw connection thus making it impossible to prevent the screw or nut, respectively, from turning while its counterpart is being unscrewed or tightened. Attempts to overcome this problem have been made either by machining inner threaded holes to the conveyor sidewall at the intended fastening points of accessories or by attaching screws or nuts to the sidewall during its fabrication by welding, for instance. Both of the above alternatives are costly and work-intensive. Furthermore, additional welds made on the sidewall degrade the wear resistance of the sidewall.

Further known in the art is the use of special screws or nuts for fixing conveyor accessories. Obviously, these fixtures are more expensive than conventional components and, additionally, need additional working of the sidewall so that the continuous section is machined to include recesses or notches suitable to hold the special fixtures in place. Also such recesses and notches are costly and time-consuming to fabricate. Moreover, the recesses/notches deteriorate the wear resistance of the sidewall.

The above-described constructions cause many kinds of complications in the manufacture and service of conveyors.

In order to overcome the above disadvantages, a novel conveyor frame construction and method for manufacturing the same are now disclosed. In accordance with the present invention, the conveyor frame sidewall is made from a continuous section having a substantially S- or Z-shaped cross section.

The benefits of the present invention include easy and rapid mounting of conveyor accessories. Furthermore, the construction according to the invention is inexpensive, stiff and more durable under wearing stress.

More specifically, the belt conveyor frame according to the invention is characterized by what is stated in the characterizing part of claim 1 and the manufacturing methods of the belt conveyor frame according to the invention is characterized by what is stated in the characterizing parts of claims 3, 4, 5 and 6.

In the following, the invention is described in more detail by making reference to the appended drawings, in which

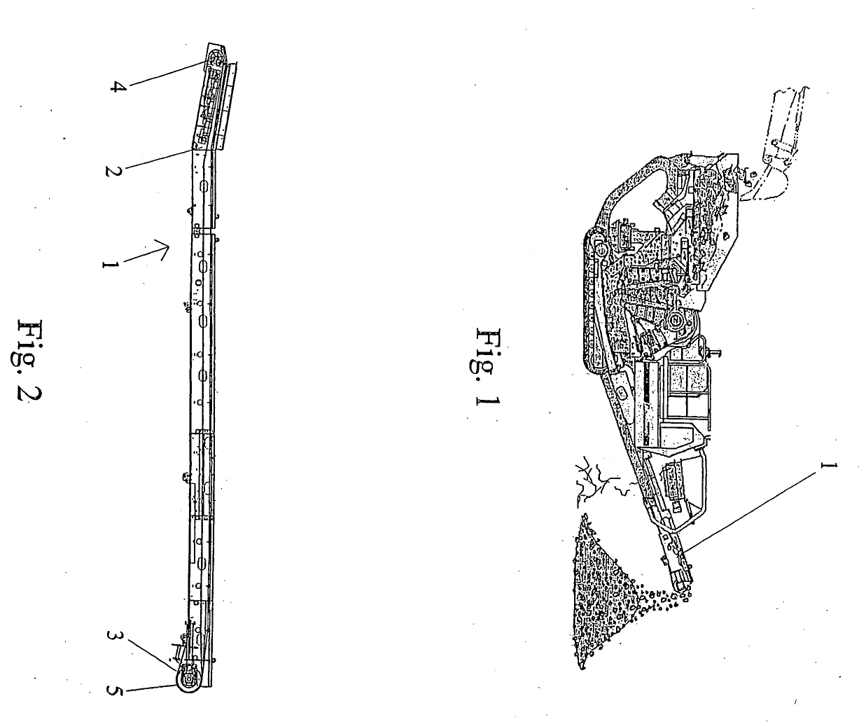

FIG. 1 shows a mineral material processing unit equipped with a typical belt conveyor;

FIG. 2 shows a side elevation view of a typical belt conveyor employed in the transfer of bulk materials;

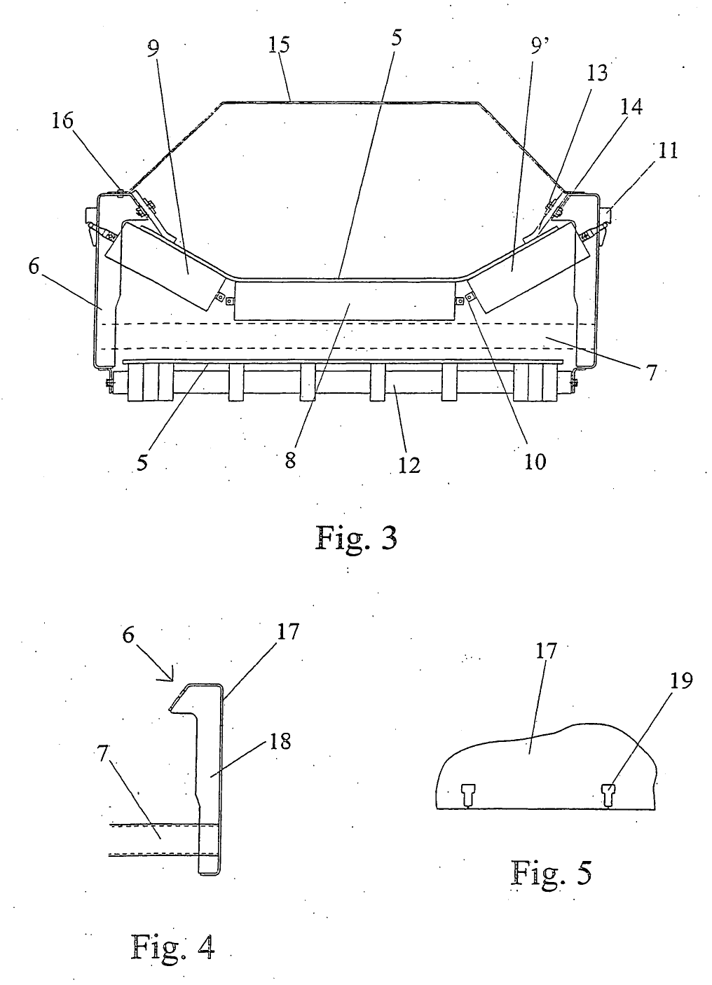

FIG. 3 shows a cross section of a typical belt conveyor;

FIG. 4 shows an enlarged view of a detail of the belt conveyor of FIG. 3;

FIG. 5 shows a detail of a continuous section of a belt conveyor equipped with notches suitable for accommodating a special screw;

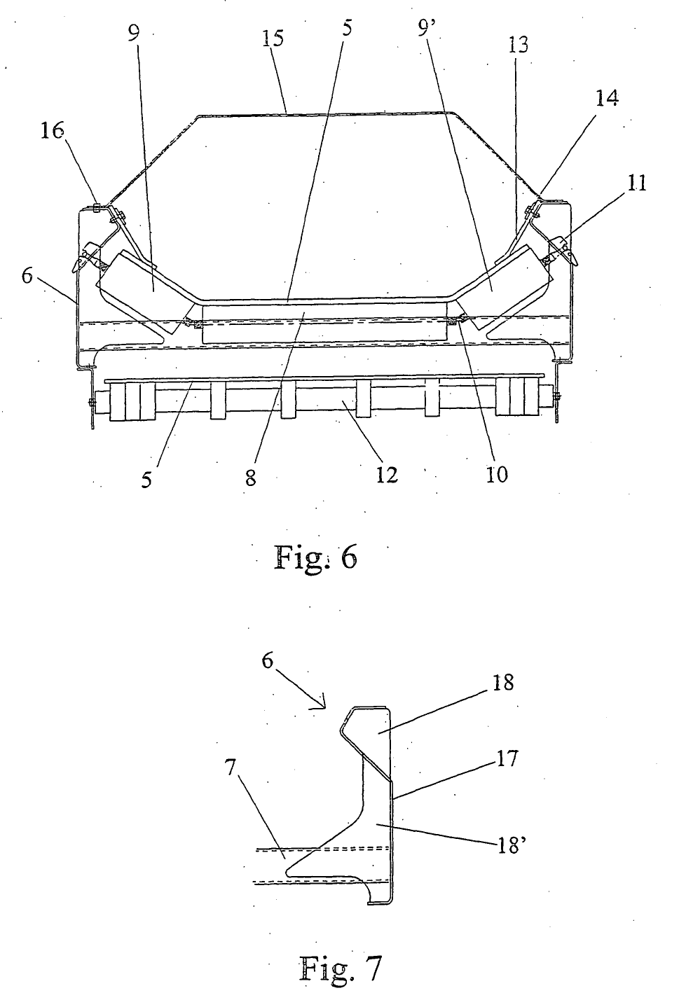

FIG. 6 shows a cross section of a belt conveyor construction according to the invention;

FIG. 7 shows an enlarged view of the sidewall structure of the belt conveyor of FIG. 6 according to the invention; and

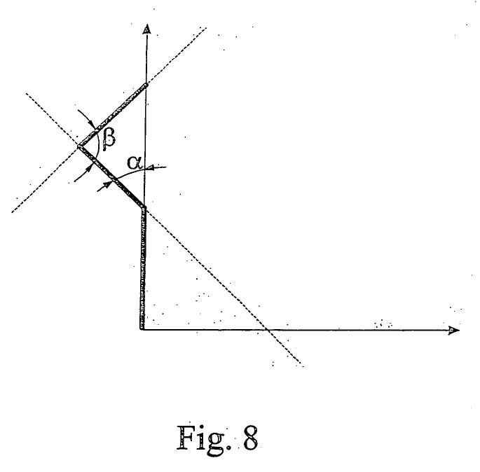

FIG. 8 shows an exemplary embodiment of the manufacturing method of the sidewall continuous section of a belt conveyor frame according to the invention.

Referring to FIG. 1, therein is shown a mineral material processing unit equipped with a belt conveyor 1. This kind of processing unit may be, e.g., a feeder, crusher or screening unit.

In the belt conveyor 1 shown in FIG. 2 typically suited for the transport of bulk materials such as crushed rock, the main components are a conveyor frame 2, a driven head pulley 3, a tail pulley 4 and a conveyor belt 5. Conventionally, the conveyor belt 5 is adapted to run as an endless loop about the head pulley 3 and the tail pulley 4 mounted in bearings at the ends of the conveyor frame 2, whereby the belt is driven by head pulley. The loaded leg of the belt is additionally backed by support rollers mounted at a suitable distance from each other in the conveyor frame 2. Under the conveyor frame, facing the return leg of the belt, are generally mounted support rollers known as jockey rollers serving to support the belt return.

The conveyor frame 2 may comprise plural modular frame elements connected to end-to-end with each other, either permanently or detachably. The modular frame elements may also be connected with each other in a fashion permitting connection of the modular elements with a bend/angle therebetween.

FIG. 3 shows the cross section of a typical belt conveyor perpendicular to the longitudinal axis of the conveyor. Hanging between the sidewalls 6 of the conveyor frame is mounted a modular roller set comprising belt support rollers 8, 9, 9′ adapted rotary on a cable 10 or a pivotally linked support shaft such that the cable 10 or the pivotally linked shaft is passed through each one of the support rollers at the roller center axis. The conveyor belt 5 running on the support rollers forms a trough on which the bulk material travels during the operation of the conveyor.

Along its return leg, belt 5 is supported by support roller set 12.

The cable 10 or the pivotally linked shaft on which the support rollers 8, 9, 9′ rotate is generally shaped such that its ends are provided with eylets insertable into slots made to the sidewalls 6 of the conveyor frame or lockable to the conveyor frame with wedges 11. This arrangement permits easy and fast installation of the conveyor roller set to the conveyor frame.

Conventionally, the conveyor is also equipped with certain accessories such as a side panel apron 13 and a dust cover 15. The function of the side panel apron is to prevent bulk material from falling off from the conveyor belt 5 via the gap between the conveyor belt and the sidewall 6 of the conveyor frame. The dust cover 15 serves to enclose the possibly dusty bulk material inside the conveyor so that the dust emissions cannot escape to the surroundings. The conveyor may further be complemented with, e.g., a dust vacuuming manifold/piping or a water spraying manifold/piping that either replaces or complements the function of the dust cover. Both of such installations aim at reduction of environmental load due to emissions from dusty bulk materials.

The side panel apron 13 and dust cover 15, as well as other accessories, are generally fixed in place with screws 14, 16.

FIG. 4 shows in an enlarged view a detail of the belt conveyor of FIG. 3. As is evident from the diagram, the conveyor frame sidewall 6 is comprised of a continuous section 17 and a stiffener plate 18. The pre-engineered sidewall is fastened to cross members 7, whereby the conveyor frame 2 is formed.

The continuous section of the conveyor frame sidewall is made from sheet steel by shearing and bending. In the exemplary embodiment shown in the diagram, the sidewall continuous section 17 can be said to essentially resemble letter C, whereby the sheet is bent so as to conceal the sidewall stiffener plate 18 in a view taken from the side and top of the conveyor frame and also a portion of the conveyor frame remains concealed in a view taken from inside the conveyor frame. The continuous section may additional be bent so that it conceals the sidewall stiffener plate at least partially when the conveyor frame is viewed from below. If reasons related to manufacture or visual look of the conveyor so urge, the number of bends may be increased to give the continuous section a shape essentially resembling letter G, for instance. In its simplest form, the cross section of the continuous section may be shaped as letter J or L.

The screw connections 14, 16 fastening the accessories may be formed by way of, e.g., machining to the conveyor frame 6 an inner-threaded hole that in the mounting of accessories 13, 15 accommodates tightening a screw thereto. In lieu of a threaded hole, the conveyor frame may be provided with holes having nuts attached thereto by welding, for instance, whereby in the mounting of accessories a screw of the same thread size as that of the nut attached into the hole is tightened thereto. The screw connections fastening the accessories may also be implemented by way of attaching to the conveyor frame an externally-threaded member that can be passed through a hole made in the accessory whereupon a nut can be tightened on the externally-threaded member. The externally-threaded member fixed to the conveyor frame may be, e.g., a bolt or a length of threaded rod fastened by welding.

In certain cases in lieu of the inner-threaded bolt/hole made on the continuous section 17 of the conveyor frame sidewall 6 for mounting accessories 13, 15, a special type of screw or nut (not shown) may be used, whereby the continuous section of the conveyor frame sidewall must be provided with a keyhole 19 shaped to accommodate the keybase of such a special screw/nut thus locking the threaded component in a nonrotary fashion to the conveyor frame. A continuous section 17 with keyholes 19 suited for this purpose is shown in FIG. 5.

In FIG. 6 is shown the cross section of a belt conveyor construction according to the invention taken perpendicular to the longitudinal axis of the conveyor, while in FIG. 7 is shown an enlarged view of the belt conveyor sidewall structure of FIG. 6 and fastening of the sidewall to a cross member of the conveyor frame.

In FIGS. 6 and 7 are identifiable the same members as those used in the conventional conveyors of FIGS. 4 and 5 discussed above. However, here the characteristic feature of the conveyor construction according to the invention is the novel construction of a conveyor frame sidewall 20.

In the conveyor construction according to the invention, the conveyor frame sidewall 20 is formed by way of fabricating a sidewall continuous section 21 through shearing and bending a sheet steel plate in at least two different direction so as to obtain the essentially letter S- or Z-shaped cross section of the sidewall continuous section 21. In this context the meaning of two different direction is that the sheet bending angle relative to the vertical plane of the continuous section varies between a positive and a negative angle. This kind of shape is partially open and partially closed in a view taken on the sidewall continuous section 21 from both inner side and outer side of the conveyor frame.

Most advantageously, a stiffener plate 22 of the sidewall 20 is made from two parts 22 and 22′, whereby the structure becomes very stiff against both bending and torsional stresses imposed on the sidewall.

In addition to the strength and stiffness of the sidewall construction according to the invention, it also offers uncomplicated mounting of conveyor accessories. After the conveyor frame 2 is equipped with appropriate support rollers 8, 9, 9′ and belts 5, the sidewall apron 13 can still be easily mounted and dismounted inasmuch as both sides of the screw connection 14 are visible and easily accessible with tools from the external side of the conveyor frame. Also the dust cover 15 is easy to mount and dismount, since both sides of the screw connection 16 are as well visible and easily accessible with tools from the external side of the conveyor frame.

FIG. 8 shows an exemplary embodiment of the manufacturing method of the continuous section of the belt conveyor sidewall, now having the sidewall continuous section drawn in a coordinate system. In the manufacturing method, the blank of the sidewall continuous section is first bent in a direction that forms a positive angle α relative to the planar portion of the continuous section that is aligned parallel to the vertical axis of the coordinate system. In the second step of manufacture, the plate of the continuous section is bent in a direction that forms a negative angle β relative to the plane of the first bent portion. By bending the blank of the continuous section in this fashion in two angles opposite to each other, the continuous section finally assumes a shape having a cross section essentially resembling letter S or Z. While in the exemplary embodiment shown in the diagram, angle ax is about 45° and angle β is about 90°, the implementation of the invention is not limited to the use of the bending angles mentioned in this example.

In the context of this description, the definitions of negative and positive angle are the same as those conventionally used for the angles of a unit circle in trigonometry.

In the exemplary embodiment of FIG. 8, the bending of the continuous section blank into the desired shape of its cross section is shown to take place in two steps. Obviously, the bends may as well be made in a single step. The continuous section can be fabricated by shearing a blank and then bending it stepwise in different angles or, alternatively, the blank may be machined in a single step using suitable press tools, possibly combined with shear tools, so that all the bends of the continuous section are formed by a single stroke of a bending press. Obviously, the invention is not limited to a given order of forming the angles of the cross section of the continuous section. When necessary, the press may be complemented with a shear tool such that the continuous section is separated from the raw material sheet at the same time as the press stroke makes the required bends.

The cross section of the sidewall continuous section may also be shaped with plural bends at desired angles in the fashion shown in the exemplary embodiment of FIG. 8. Even herein, an essential feature of the invention is that at least a major portion of the cross section of the continuous section shall assume essentially the shape of letter S or Z, whereby at least two successive bends must be made at angles opposite to each other in the manner disclosed in the appended claims.

The continuous section of the conveyor sidewall according to the invention may also be fabricated by die extrusion using a die with an exit opening substantially equal in shape to the desired cross section of the sidewall continuous section, whereupon the raw material of the continuous section, e.g., aluminum, can be extruded through the die and allowed to cool thus forming the sidewall continuous section according to the invention.

Still further, the sidewall continuous section according to the invention may alternatively be fabricated by combining several basic continuous sections, which may be either flat or bent by their cross section, into the sidewall continuous section according to the invention. Such simple continuous sections can be joined to each other by welding, for instance.

Since the mounting of accessories on the conveyor sidewall construction according to the invention can be carried out using standard screws and nuts, there is no need for the use of expensive special screws and/or nuts. Furthermore, since no recesses or slots need be made on the present kind of conveyor sidewall, the conveyor frame is less costly to manufacture and offers improved resistance to wear.

As the invention is not limited to any specific material of the conveyor frame, also other materials than steel may be used in the manufacture of the frame structure.

Still further, the conveyor frame may comprise a single length of the sidewall continuous section or, alternatively, the frame can be assembled from plural separate modular sidewall units so that a conveyor frame longer than a single modular sidewall unit results.

Neither is the invention limited to any specific assembly method of the conveyor frame, but rather, the frame components can be connected to each other by welding or using other conventionally employed fastening methods.

Besides screw connections, the mounting of accessories may be accomplished using other connection methods known in the art.

1. A belt conveyor frame, wherein the sidewall continuous section of the belt conveyor frame supports a modular roller set that in turn supports a conveyor belt in a manner which forms the conveyor belt into a trough suitable for transport of bulk material, characterized in that the cross section of the continuous section used in the conveyor frame sidewall is shaped to include at least two successive bends, each of them being made at an angle opposite to the adjacent bend, thus rendering the cross section substantially the shape of letter S or Z.

2. The belt conveyor frame of claim 1, characterized in that the sidewall continuous section of the belt conveyor frame is comprised of two or more lengths of modular continuous section connected end-to-end with each other.

3. A method of manufacturing the sidewall continuous section of the belt conveyor frame of claim 1, characterized in that the sidewall continuous section is made from sheet material by bending.

4. A method of manufacturing the sidewall continuous section of the belt conveyor frame of claim 1, characterized in that the sidewall continuous section is made by joining several simple continuous sections to each other.

5. A method of manufacturing the sidewall continuous section of the belt conveyor frame of claim 1, characterized in that the sidewall continuous section is made by extrusion.

6. A method of manufacturing the sidewall continuous section of the belt conveyor frame of claim 1, characterized in that the sidewall continuous section is made from sheet material by pressing.
